(19) United States
(12) Patent Application Publication
(10) Pub. No.: US 2005/0079392 A1
(43) Pub. Date: Apr. 14, 2005

(54) Fuel cell apparatus and method of controlling the same

(75) Inventors: Yasuaki Norimatsu, Hitachi (JP); Fumio Murabayasi, Naka (JP); Akihiko Kanouda, Hitachinaka (JP); Akira Tanaka, Mito (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(73) Assignee: Hitachi, Ltd., Tokyo (JP)

(21) Appl. No.: 10/920,357

(22) Filed: Aug. 18, 2004

(30) Foreign Application Priority Data
Oct. 8, 2003 (JP) 2003-348954

(51) Int. Cl. H01M 8/00; H01M 8/04; H01M 8/18; H01M 8/12; H01M 2/00; H01M 2/02; H01M 2/14

(52) U.S. Cl. 429/13; 429/34; 429/38; 429/39; 429/19; 429/22; 429/23; 429/17

(57) ABSTRACT

A fuel cell apparatus comprising a fuel cell for supplying electric power for driving a load, a fuel chamber for storing fuel, a water storage chamber for storing water, an adjuster connected to the fuel chamber, water storage chamber and the fuel cell, wherein the adjuster supplies mixed fuel to the fuel cell, the mixed fuel being obtained by controlling and mixing fuel supplied by the fuel chamber and water supplied by the water storage chamber.

### CLAIM OF PRIORITY

The present application claims priority from the Japanese application serial No. 2003-348954, filed on Oct. 8, 2003, the content of which is hereby incorporated by reference into the application.

### FIELD OF THE INVENTION

The present invention relates to a fuel cell apparatus and a method of controlling the same.

### BACKGROUND OF THE INVENTION

In recent years, portable electronic instruments such as telephones, book type personal computers, audio/visual devices, mobile terminals, etc have been populated rapidly. These instruments have been driven by secondary batteries. Among the secondary batteries, sealed type lead batteries, Ni/Cd batteries and Ni/hydrogen batteries have progressed; new type secondary batteries such as Li ion batteries have also appeared, that leads to downsizing-light weight with high energy density.

However, secondary batteries need a charging device that needs charging for a relatively long period of time, which has a number of problems for a long-term continuous operation of the portable electronic instruments. Therefore, demands for fuel cells that need no charging is increasing, so as to meet the trend of an increasing demand of high output density power sources, i.e. a long-term continuous use.

Fuel cells that use hydrogen are well known. Although the fuel cells of this type are operated at around 80° C. or higher, fuel cells using liquid fuel, which directly oxidize the fuel at a fuel electrode are operated at around room temperature. There are fuel cells of the type, which directly oxidize methanol called DMFC as a typical example. A technique for supplying fuel to DMFC is disclosed in Patent publication No. 1, for example. The technique does not need moving elements such as a reformer or pumps for supplying fuel. Thus, it is possible to downsize and lightweight the fuel cell apparatus. Further, a technology, which stores water generated at the air electrode by electric generation reaction is disclosed in Patent publication No. 2.
Patent Publication No. 1: Japanese Patent Laid-open 2000-106201
Patent Publication No. 2: Japanese Patent Laid-open 2002-169625

### BRIEF DESCRIPTION OF THE DRAWINGS

FIG. 1 is a block-diagram of a fuel cell apparatus according to the present invention.

FIG. 2 is a diagram showing a status of input-output around an adjuster.

FIG. 3 is a diagram showing an input-output of signals of the fuel cell apparatus.

FIG. 4 is a diagram showing an input-output of signals of the fuel cell apparatus of another example.

FIG. 5 is a flow chart showing an operation at the time when an apparatus switch is ON.

FIG. 6 is A flow chart showing an operation at the time when the apparatus is in service.

FIG. 7 is a flow chart showing an operation at the time when the apparatus switch is OFF.

FIG. 8 is a diagram showing relationship between the fuel cell and a water recovery section.

### DESCRIPTION OF INVENTION

In the conventional fuel cell apparatus, if fuel of a high methanol concentration is used, a phenomenon, so called cross-over flow, happens where fuel permeates from a fuel electrode to the air electrode through an electrolyte membrane, so that efficiency of power generation decreases. Therefore, fuel of a low concentration had to be used. However, if the low concentration fuel is used, a large amount of water remains in the fuel chamber, which results in a heavy structure of the fuel cell. Further, water may be recovered as waste, and it needs a lot of time to process the wastewater.

The present invention provides a fuel cell apparatus comprising a fuel cell for supplying electric power to drive a load, a fuel chamber, a water storage chamber, and an adjuster, connected to the fuel chamber, water storage chamber and fuel cell, for controlling an amount of fuel supplied from the fuel chamber and an amount of water from the water storage chamber to supply the fuel mixed with water.

According to the present invention, it is possible to achieve that an increase of output and fuel efficiency, reduction of fuel permeation due to cross-over, and complete consumption of fuel employing a high concentration fuel are fulfilled.

### PREFERRED EMBODIMENTS FOR PRACTICING INVENTION

In the following, the fuel cell apparatus will be explained.

In the conventional fuel cell of the direct liquid fuel type, electrochemical reaction takes place during no load or low load operation at the time of system shutdown, if fuel stays at the fuel electrode. Therefore, in case where a control of fuel supply by a pump, etc is not done, fuel consumption rate becomes low if there is a change in load, including the system shutdown. Further, in order to react fuel and water without excess and shortage at the fuel electrode, fuel of a concentration higher than a certain level cannot be used (in case of methanol, 64% by volume is the maximum concentration), it was difficult to constitute a downsized system that is capable of operating for a long period of time. If the low concentration fuel is used so as to prevent the cross over, a specific device for informing a user of an amount of remaining water in the fuel chamber is necessary.

Further, in addition to the treatment of the remaining water, water produced in the course of fuel reaction should be processed. Since an internal resistance of the fuel is larger than that of other type of batteries, and since direct fuel type fuel cells have a lower output power and a lower output density, it is necessary to take some counter-measures to a high load operation of the fuel cell or a instantaneous output demand.

FIG. 1 shows a block diagram of one embodiment of the fuel cell apparatus according to the present invention. In FIG. 1, the fuel cell 10 is a direct liquid fuel type, which directly oxidizes methanol (DMFC). The fuel chamber 11 and water storage chamber 12 are so disposed as to be detaching from the fuel cell. Fuel is supplied to the adjuster 13 through a fuel pipe p1 and water is supplied to the adjuster 13 through a pipe p2. The fuel and water are mixed to make a suitable concentration of water-methanol solution. The mixed fuel prepared at the adjuster is supplied to the fuel electrode of the fuel cell 10 through a fuel adjusting pipe p3.

Water is discharged from the air electrode of the fuel cell 10 through a water recovery pipe p4, and the discharged water is recovered by a water recover section 14. The recovered water is stored by means of a water compensate pipe p5 in the water storage chamber 12 and is reused.

Since the water for adjusting the concentration is reused, the mixed fuel need not contain all water necessary for the fuel cell, and a higher concentration fuel mixture can be used. Therefore, if the operating time of the fuel cell 10 is the same, the fuel chamber can be downsized and light-weighted in case of the present invention.

As described above, it is possible to know the remaining amount of fuel in the fuel chamber 11 so as to completely consume fuel. The user needs not treat water, in this case.

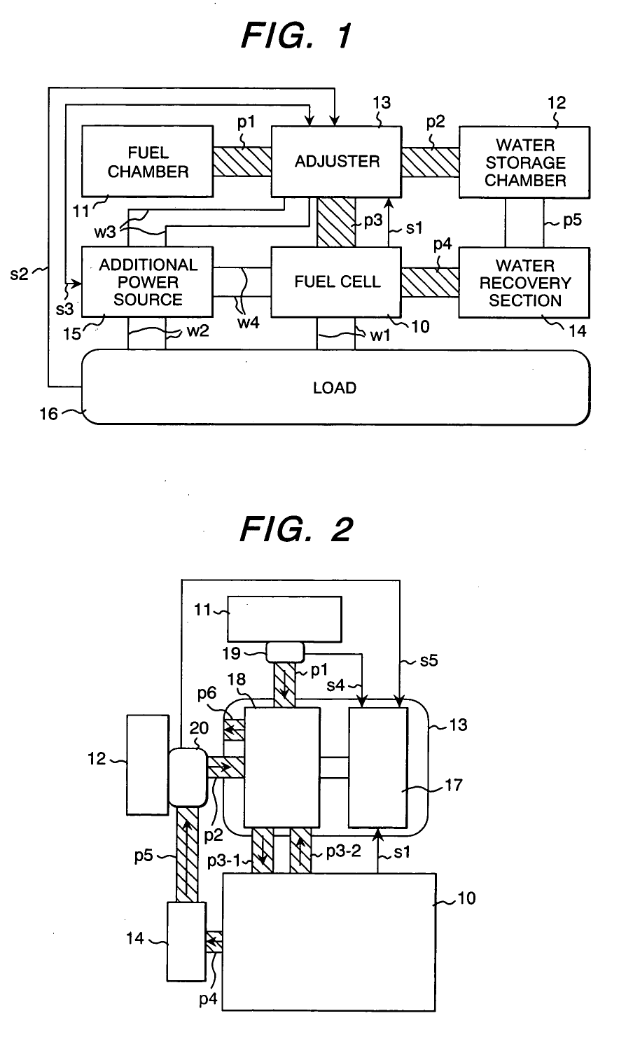

The fuel cell 10 is electrically connected to a load 16 by means of a power line w1, to the additional power source 15 by means of a power line w2, and to the adjuster 13 by means of a power line w3. A fuel cell status signal s1 informing the user of the status of the fuel cell is issued from the fuel cell 10 to the adjuster 13. A load status signal s2 is issued from the load 16 to the adjuster 13. A additional power source status signal s3 is issued from the additional power source 15 to the adjuster 13. The adjuster 13 will be explained by reference to FIG. 2.

The adjuster 13 comprises an adjuster driving section 18 for supplying fuel and water to the fuel electrode of the fuel cell, an adjuster control section 17 for controlling the power control of the adjuster driving section 18.

Fuel and water are supplied from the fuel chamber 11 and water storage chamber 12 by means of liquid transport device (not shown) to the adjuster 13. As the liquid transport device, pumps, micro-pumps, etc are used. The adjuster driving section 18 controls the supply amounts from the fuel chamber 11 and water storage chamber 12, and sends them to the fuel cell 10 through the pipe p3, and receives through the fuel adjuster fuel return pipe p3-2.

An example of detection of remaining amounts of fuel and water will be explained in the following.

A first example for detecting the remaining fuel and water amounts employs a method of detecting weights of the fuel chamber and water storage chamber.

A second example for detecting the remaining amounts of fuel and water employs a fuel pack, which is detachable from the fuel cell. The fuel pack is like a air balloon, which is expanded to be filled with fuel therein, and the restoring force of the elastic material of the balloon ejects fuel. By measuring the ejecting pressure, the remaining amount is determined.

A third example for detecting the remaining amounts of fuel and water employs a small sized fuel cell of a small electricity generation and of small fuel permeability, which may be a fuel direct type fuel cell and is adhered to the wall of the fuel cell. If one fuel cell is adhered, an amount of the remaining fuel is determined by an output. If a plurality of fuel cells is adhered, the amount is determined by detecting an output of each of the fuel cells.

Next, control of the fuel cell apparatus is explained. In one example of control of the fuel cell apparatus, the fuel chamber 11 is communicated with the fuel pipe p1 through a fuel chamber mounting-dismounting device 19. The fuel chamber mounting-dismounting device 19 is provided with a detector of the fuel remaining amount. When the detector detects the fuel remaining amount in the fuel chamber, the detected result is sent as a signal s4 to the control section 17 of the adjuster. The water storage chamber 12 is communicated with water pipe p2 through water storage chamber mounting-dismounting device. The water remaining detection device detects the amount of remaining water in the water storage chamber 12 to send signals s5 as water remaining detection signals to the adjustor control section 17.

The fuel electrode of the fuel cell is provided with a concentration sensor or a remaining detection sensor. The detection results of the concentration sensor or of the remaining detection sensor are sent to the adjuster control section 17 as the fuel cell status detection signals S1. The adjuster control section 17 controls the adjuster driving section 18 so that the concentration and the remaining amount become the predetermined values, as feedback information of the concentration and remaining amount from the fuel electrode of the fuel cell 10. The targeted concentration value at this stage is set to be such a value that the permeation of fuel is as little as possible, thereby to increase efficiency of the electric generation. The adjuster driving section 18 circulates fuel adjusted between the fuel electrode 10 and the adjuster driving section 18.

A second example of the control of the fuel cell apparatus employs a concentration sensor disposed to at least one of the fuel chamber 11, water storage chamber 12 and adjuster 18, whereby more accurate control can be conducted.

A third example of the control of the fuel cell apparatus employs an air passage p6 disposed between the adjuster control section 18 and atmosphere, and a pressure sensor (not shown) and vane system (not shown), both disposed to the air passage p6. By controlling the opening-closing of the vane system, accumulation of gas between the adjuster driving section 18 and fuel electrode of the fuel cell 10 is prevented. According to this system, excess accumulation of carbon dioxide generated at the fuel electrode of the fuel cell 10 is avoided.

A fourth example of control of the fuel cell apparatus employs a temperature sensor (not shown) disposed to the fuel cell to send detected signals to the adjuster control section. A memory in the adjuster control section 17 stores targeted concentration values of “HIGH”, which means a high targeted concentration, and “NORMAL”, which means a concentration where fuel consumption efficiency is good. If the temperature of the fuel cell is lower than the predetermined one, the targeted concentration is set to “HIGH”, and if the temperature is higher than the predetermined one, the targeted concentration is set to “NORMAL”. When the temperature is low, permeation of fuel from the fuel electrode to the air electrode is not too much, and the temperature can be elevated by increasing the concentration. As a result, an output of a certain level is obtained even under a lower temperature condition, and the permeation of fuel can be maintained to a constant level over the range of from low temperature to high temperature.

A fifth example of control of the fuel cell apparatus employs a plurality of adjusting tanks (not shown) for storing fuel solutions having predetermined different concentrations, the adjuster driving section being provided with the adjusting tanks. When the adjusting tanks and the fuel electrode of the fuel cell 10 are switched, a speedy change-over of the concentrations can be done.

A sixth example of control of the fuel cell apparatus employs a current detector for detecting current of a power supply section from the fuel cell 10 to load 16. A signal of current detected by the current detector is sent to the adjuster control section 17. When a value of current exceeds a certain value, it is possible to avoid lack of fuel in the fuel cell 10 by increasing the target value of fuel supply amount.

A seventh example of control of the adjuster control section employs a system wherein the additional power source 15 is used as secondary battery charged by the fuel cell 10 to work as a charge detection function. The detected charge signal is sent to the adjuster control section 17. As a result, it is possible to prevent overcharge and over-discharge by changing the target value of fuel concentration to be supplied to the fuel cell 10 to “HIGH”, when the charge amount is low, and by changing the target value to “NORMAL”, when the charge amount is larger than the certain value.

In accordance with demands, one or more of the above-mentioned examples may be used singly or in combinations. Next, a method of power supply will be explained.

The output of the fuel cell 10 is converted into a suitable voltage and is used for driving the load 16, the adjuster 13, etc. The direct liquid fuel cell such as DMFC uses the additional power source 15, because output density of the fuel cell is low. The additional power source 15 is also used as a driving power source for the adjuster 13, which is used to re-start supply of fuel to the fuel cell from the status that the fuel supply to the fuel cell is stopped. The additional power source 15 uses at least one of a secondary battery, a power supply by AC adapter, an electric double-layered condenser and an electrolyte condenser.

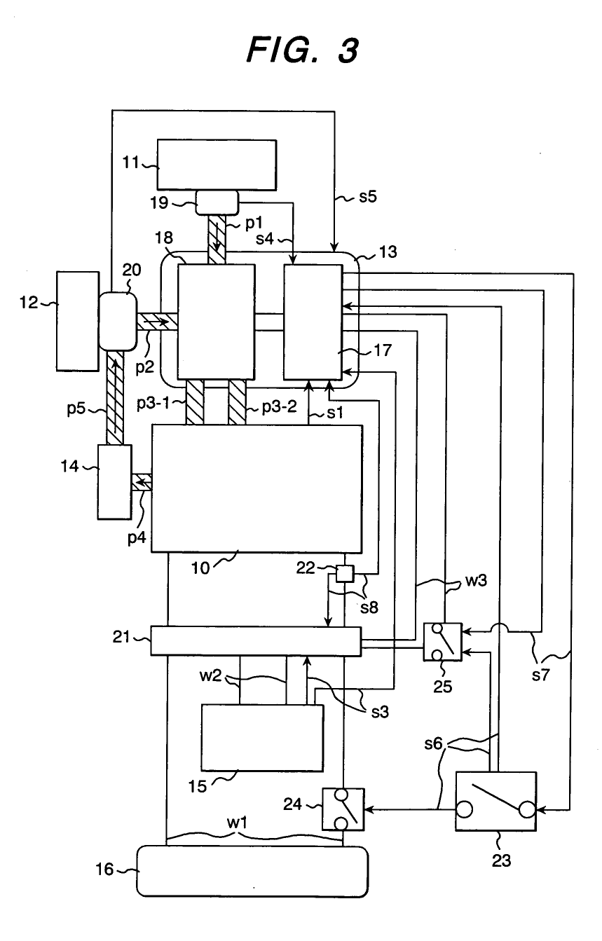

The first example of power supply will be explained. FIG. 3 shows a diagram of connection between the power of the fuel cell apparatus and signals in detail. As the additional power source 15, a secondary battery being capable of charge-discharge and having a function of detecting charge amount. The additional power source 15 is connected through the charge-discharge circuit 21 to the fuel cell 10 and the load 16 in parallel with each other. The charge-discharge circuit 21 conducts switching of the circuit in response to fuel cell output current detection signals s8 detected by the current detector 22. When the current is a certain value or more, the additional power source 15 discharges, in power conversion, to the load 16; when the current is less than the certain value, the additional power source 15 is charged by the power converted output from the fuel cell 10.

At the same time, switching control of the power supply to the adjuster 13 is done. When the current is the certain value or more, the additional power source 15 discharges, in power conversion, to the adjuster 13; when the current is less than the certain value, the output power-converted from the fuel cell drives the adjuster 13. As a result, it is possible to increase efficiency of the fuel consumption, so that the time of high current output becomes shorter, and the power loss due to internal resistance of the fuel cell can be made smaller.

In the second example of power supply, a primary battery having a function for detecting a remaining energy is used as the additional power source 15. The additional power source 15 is connected through the charge-discharge control circuit 21 to the fuel cell 10 and the load 16 in parallel with each other. The charge-discharge control circuit 21 conducts switching the control of the circuit in response to the fuel cell output current detection signal s8 from the current detector 22 disposed to the power conversion section between the fuel cell 10 and the load 16. If remaining energy in the additional power source 15 is detected by the remaining energy detection means, the additional power source 15 discharges in power conversion when the current is more than the certain value. When the current is less than the certain value, discharge from the additional power source is stopped. As a result, a high power discharge time becomes shorter, thereby to lessen the power loss due to the internal resistance of the fuel cell 10.

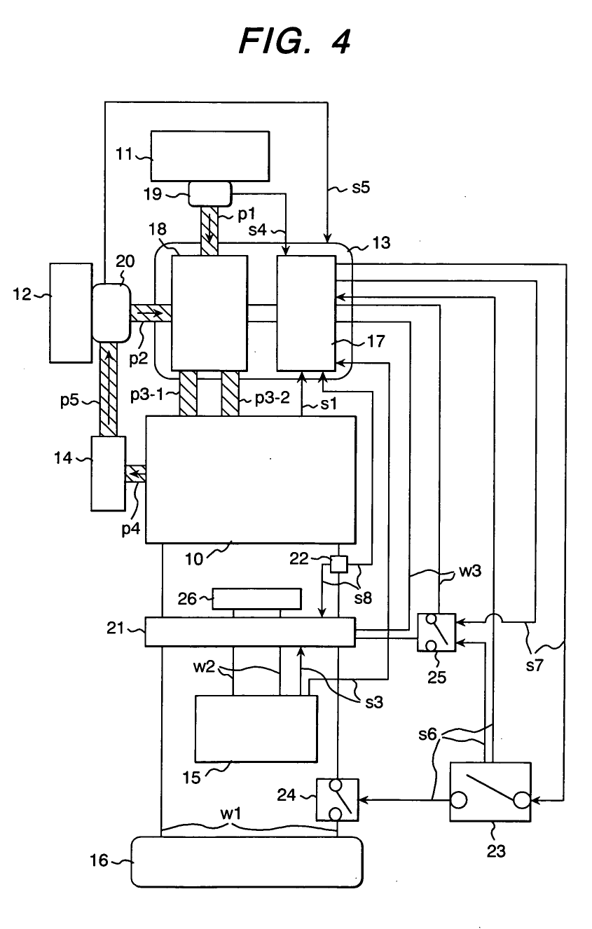

A third example will be explained by reference to FIG. 4. In FIG. 4, an AC adapter 26 is added to the circuit shown in FIG. 3. The AC adapter 26 is connected through the charge-discharge control circuit 21 to the fuel cell 10, the additional power source 15 and the load 16 in parallel with each other. The charge-discharge control circuit 21 switches the circuit in response to the voltage at the connecting terminals of the AC adapter 26. A current detection device 22 is disposed at a supply section from the fuel cell 10 to the load 16. The fuel cell power output current detection signal s8 detected by the current detection device 22 is input into the charge-discharge control circuit 21. The charge-discharge control circuit 21 suppresses consumption of fuel by controlling the output of the fuel cell to a certain level in response to the output current detection signal s8. The circuit is switched so as to mainly use the output of the AC adapter 26 is power-converted by the charge-discharge control circuit 21. The AC adapter 26 switches the charge-discharge control circuit 21 in such a direction that the additional power source 15 is charged. When the voltage of the connecting terminals of the AC adapter 26 becomes lower than the certain level, the charge-discharge control circuit 21 changes to the operation explained in the first example of power supply.

In the fourth example of power supply, the AC adapter 26 is connected through the charge-discharge control circuit 21 to the fuel cell 10, the additional power source 15 and the load 16 in parallel with each other. The charge-discharge control circuit 21 switches the circuit in response to the voltage of the connecting terminal of the AC adapter 26. In detail, current is detected by the current detection device 22 disposed at the power supply section, the current being supplied from the fuel cell 10 to the load 16. The fuel cell output current detection signal s8 of the current detection device 22 is input into the charge-discharge control circuit 21. The input signal controls the output of the fuel cell 10 to a certain level or less to thereby suppress the consumption of fuel and to switch the circuit to use mainly the output of the AC adapter, the output being power-converted by the charge-discharge control circuit 21. The AC adapter 26 stops discharge from the additional power source 15. When a voltage of the AC adapter 26 becomes lower than a certain level, operation of the charge-discharge control circuit changes to the operation explained in the second example of power supply.

In addition to the example of the power supply mentioned above, condensers such as an electrolyte condenser, electric double layer condenser may be connected between the fuel cell 10 and the load 16.

In the following, a method of start-up and stop of the fuel cell apparatus will be explained.

A first example of a method of controlling the start-up and stop of the fuel cell apparatus is explained by reference to FIG. 3. The fuel cell apparatus shown in FIG. 3 comprises an apparatus switch 23, a load power supply switch 24, and an adjuster power supply switch 25. The apparatus switch 23 holds ON as an output signal upon operation by a user, and holds OFF as an output signal upon the operation by the user or OFF signal from the adjuster. The load power supply switch 24 switches power supply to the load to ON or OFF in response to the signal s6 from an apparatus switch status detection, the s6 representing the ON or OFF status of the apparatus switch 23. The adjuster power supply switch 25 changes the power supply to the adjuster control section to ON in response to the logical sum of the apparatus switch status detection signal s6 from the apparatus switch 23 and the adjuster control status detection signal s7 from the adjuster control section 17. When both of the load power supply switch 24 and apparatus switch 23 are OFF, the adjuster power supply switch 25 changes power supply to the adjuster control section 17 to OFF. The start-up and stop of the fuel cell apparatus are selected by switching the adjuster power supply switch 25.

A second example of a method of controlling start-up and stop of the fuel cell apparatus employs an information device such as personal computers as a load. Compared with the first example of the method of start-up and stop of the fuel cell apparatus, the load 16 can output ON or OFF signals to the apparatus switch 23 and the load power supply switch 24. The load power supply switch 24 in the first example of the start-up and stop of the fuel cell apparatus switches power supply to ON upon the logical sum of the ON output signals from the apparatus switch 23 and the load 16, and the load power supply switch 24 switches the power supply to OFF when the signals from the load 16 and the apparatus switch 23 are OFF. The apparatus switch 23 may turn off in response to OFF signal from the load 16.

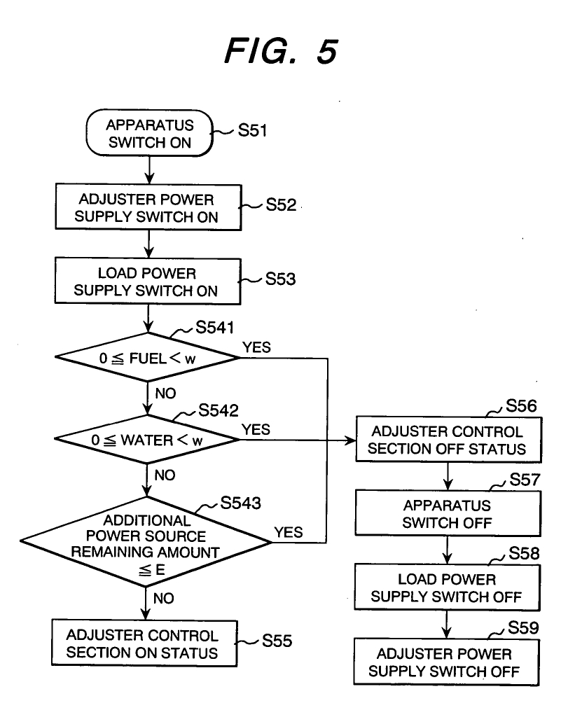

The start-up and stop of the fuel cell apparatus will be explained by reference to flow charts shown in FIGS. 5, 6 and 7.

A first example of a control method of start-up and stop of the fuel cell apparatus will be explained. FIG. 5 shows a flow chart when the apparatus switch is ON.

When a user makes the apparatus switch 23 ON, the apparatus switch 23 is kept ON. The adjuster power supply switch becomes ON (S52) in response to the apparatus switch status detection signal s6 from the apparatus switch 23, and then the load power supply switch 24 becomes ON (S53) so that power supply from the additional power source 15 to the load 16 and the adjuster control section 17 starts. The adjuster control section 17 judges a logical product of a signal from the apparatus switch 23, a signal (S541) on an amount of remaining fuel from the fuel chamber detaching device 19, a signal (S542) on the amount of remaining water from the water storage chamber detaching device 20, and a signal (S543) on an amount of remaining power of the additional power source. When the conditions satisfy all requirements, and when the logical product is 1, the condition of the adjuster control section 17 is kept ON (S55) and the adjuster control section 17 starts to control the adjuster driving section 18.

Concerning the stop of the fuel cell apparatus, judgment stars when the logical product becomes zero upon any of signals of OFF of the apparatus switch 23, shortage of an amount of remaining fuel, shortage of an amount of remaining water, and zero of the remaining power in the additional power source.

In case of the shortage of remaining fuel or of remaining water, the condition of the adjuster control section 17 becomes OFF (S56). Thereafter, the adjuster control status detection signal s7 (S57) is output to the adjuster power supply switch 25 and the apparatus switch 23 as OFF signal. The load power supply switch 24 becomes OFF (S58) upon OFF signal of the apparatus switch 23, and the signal from the apparatus switch 23 to the adjuster power supply switch 25 becomes OFF, to thereby make the adjuster power supply switch 25 OFF (S59).

When the remaining power of the additional power source 15 is zero at the time of start, the status of the adjuster control section 17 stays as OFF (S56), and outputs an OFF signal to the adjuster power supply switch 25 and the apparatus switch 23. The load power switch 24 becomes OFF in response to an OFF signal from the apparatus switch 23, and at the same time, a signal from the apparatus switch 23 to the adjuster power supply switch 25 becomes OFF. As a result, the adjuster power supply switch 25 becomes OFF.

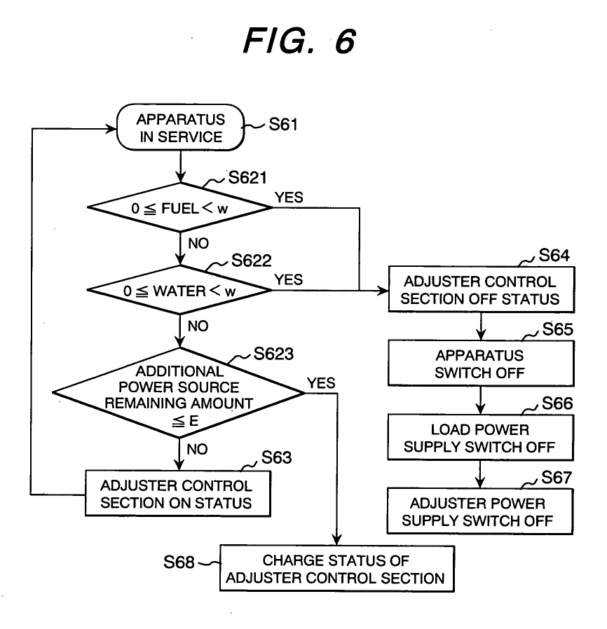

FIG. 6 shows a flow chart of operation. When the amount of remaining power of the additional power source 15 is zero during operation (S61) and when the additional power source is a secondary battery, the status of the adjuster control section 17 transforms to a charging mode (S68). S64 to S67 correspond to S56 to S59 in FIG. 5.

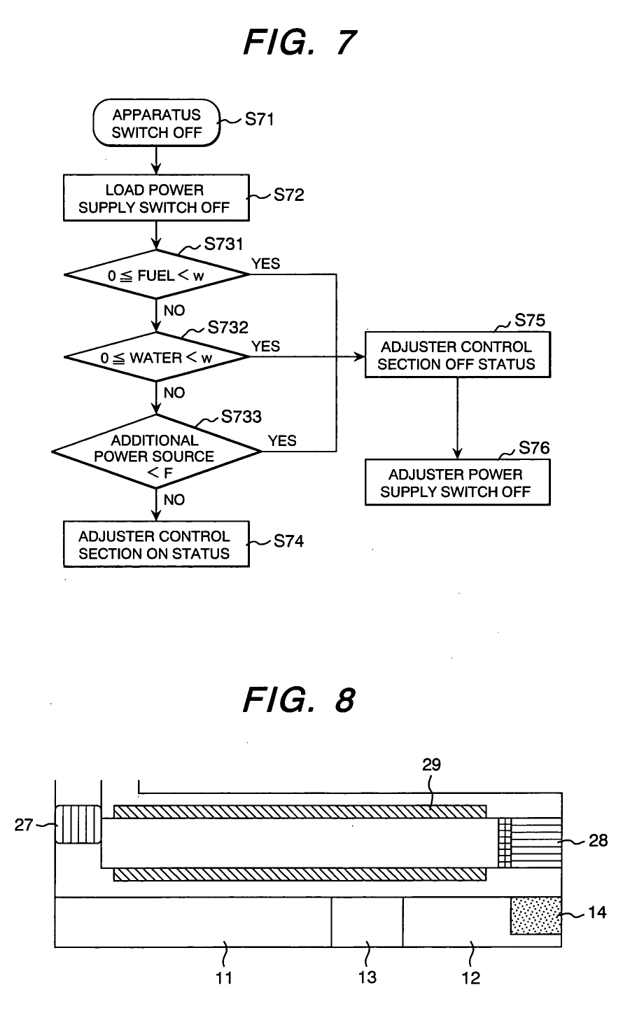

FIG. 7 shows a flow chart of the case where the apparatus switch 23 is OFF. When the apparatus switch 23 is OFF (71), the load power supply switch 24 is OFF (72) in response to a signal from the apparatus switch 23, and a signal from the apparatus switch 23 to the adjuster power supply switch 25 is OFF (S75). When the additional power source is a secondary battery, the status of the adjuster control section 17 is kept ON (D74) until full charge, but the status is kept OFF in any other cases. When the status of the adjuster control section 17 is OFF, a signal from the adjuster control section 17 to the adjuster power supply switch is OFF, and the adjuster power supply switch 25 is OFF (S76).

In a second example of a method of controlling start and stop of the fuel cell apparatus, when a user makes the apparatus switch 23 ON, the switch is kept ON. In response to the signal ON from the apparatus switch 23, the load power supply switch 24 and the adjuster power supply switch 25 turn ON to start power supply to the load 16 and the adjuster control section 17.

The adjuster control section 17 judges the logical product of signals from the apparatus switch 23, an amount of remaining fuel from the fuel chamber mounting-dismounting device 19, an amount of remaining water from the water storage mounting-dismounting device 20, and an amount of remaining power from the additional power source 15. If all the signals become 1 and if the logical product becomes 1, power supply to the adjuster control section 18 starts to control the adjuster 13. The stop where signals to the apparatus switch 23 and the adjuster power supply switch 25 are kept ON starts to judge when the logical product becomes zero in response to any one of OFF signal from the load 16, OFF signal from the apparatus switch 23, signal of shortage of remaining fuel from the fuel chamber mounting-dismounting device 19, signal of shortage of remaining water from the water storage mounting-dismounting device 20 and signal of shortage of remaining power from the additional power source 15.

If the remaining amount of fuel is short or the remaining amount of water is short, the status of the adjuster control section 17 becomes OFF, and the adjuster control section outputs OFF signal to the adjuster power supply switch 25 and the apparatus switch 23. Then, the signals from the apparatus switch 25 to the load power supply switch 24 become OFF. At the same time, the adjuster power supply switch 25 becomes OFF. When OFF signal is sent to the load 16 from the apparatus switch 23, the load 16 ends processing, then the signal from the load to the load power supply switch 24 becomes OFF, and the load power supply switch 24 becomes OFF.

When the remaining amount of power in the additional power source 15 is zero at the time of start, the adjuster control section 17 remains OFF, and outputs OFF signals to the adjuster power supply switch 25 and the apparatus switch 23. Then, the load power supply switch 24 becomes OFF in response to OFF signal from the apparatus switch 23, and signal from the apparatus switch 23 to the adjuster power supply switch 25 becomes OFF. At the same time, the adjuster power supply switch 25 becomes OFF.

When the remaining power in the additional power source 15 is zero, application which is high loading of the load 16 is prohibited by the adjuster control section 17. In case the additional power 15 is the secondary battery, the status of the adjuster control section transforms into the charging mode.

When the apparatus switch 23 is OFF, the signal from the apparatus switch 23 to the load power supply switch 24 becomes OFF, and signal from the apparatus switch 23 to the adjuster power supply switch 25 becomes OFF. OFF signal in input from the apparatus switch 23 to the adjuster control section 17 and the load 16. Then; the load 16 ends stop processing, whereby the signal from the load 16 to the load power supply switch 15 becomes OFF and the load power supply switch 24 becomes OFF. When the additional power source 15 is the secondary battery, the status of the adjuster control section 17 is maintained ON until the secondary battery is fully charged. When the status of the adjuster control section 17 becomes OFF, signal from the adjuster control section 17 to the adjuster power supply switch becomes OFF, and the adjuster power supply switch 25 becomes OFF. The detection results may be displayed in combination with a display of the apparatus, the load, etc.

Next, the water recovery section will be explained. In one example of water recovery section, a water protection-water permeable material is disposed between the air electrode of the fuel cell 10 and the water storage chamber 12 to effect permeation of water to the water storage chamber. Accordingly, it is possible to increase a fuel consumption efficiency because no device that needs driving power is used for water recovery.

In a second example for water recovery, there are formed an air blower port or an exhaust port at the air electrode of the fuel cell 10, thereby to supply air by the air blower such as a fan, disposed at the air blower port or the exhaust port. By effecting forcible air-intake in the air electrode of the fuel cell 10, the output of the fuel cell 10 increases, and at the same time, it is possible to prevent such a state that a lot of water stays in the cell due to water saturation at the air electrode.

A third example of water recovery will be explained by reference to FIG. 8. There are disposed the air blower port and the exhaust port at the air electrode of the fuel cell 10, and the air blower such as the fan is disposed at the blower port or the exhaust port to send air. A thermocouple element 29 is disposed between the air passage and the air electrode of the fuel cell in such a manner that a heating side of the thermo couple is in the fuel electrode, and the cooling side is in the air passage. A heat sink 28 is disposed at the cooling side of the thermo couple element 29 to condense steam generated at the air electrode, so that the condensed water is stored in the water recovery section 14, and the water is transported by means of a liquid transport means such as a pump to the water storage chamber 12. As a result, the temperature of the fuel cell is elevated to increase power generation efficiency of the fuel cell, and the water at the air electrode is recovered. It is possible to adjust a water recovery rate by adjusting the location of the thermo couple in the air passage.

In a fourth example of water recovery, the third example and the fourth example are combined. Water is normally recovered by the water protection-water permeable material using the fan, and if the recovery rate is small, water is recovered by the means set forth in the fourth example.

1. A fuel cell apparatus comprising a fuel cell for supplying electric power for driving a load, a fuel chamber, a water storage chamber, and an adjuster connected to the fuel chamber, water storage chamber and fuel cell, wherein the adjuster adjusts amounts of fuel supplied from the fuel chamber and water supplied from the water storage chamber, and provides the fuel mixed with water to the fuel cell.

2. The fuel cell apparatus according to claim 1, wherein there is disposed a water recovery section in the water storage chamber, for recovering water discharged from the fuel cell.

3. The fuel cell apparatus according to claim 1, wherein the fuel chamber has a fuel detection device for detecting a remaining amount of fuel in the fuel chamber, and the water storage chamber has a water detection device for detecting an amount of water therein, and wherein the adjuster adjusts supply amounts of fuel and water in response to the detected results of the fuel detection device and water detection device.

4. The fuel cell apparatus according to claim 1, wherein the fuel cell comprises a fuel detection device for detecting a remaining amount of fuel in the fuel chamber, and a water detection device for detecting an amount of water in the water storage chamber, and wherein the adjuster adjusts supply amounts of fuel and water in response to the detected results of the fuel detection device and water detection device, and wherein a concentration of fuel supplied to the fuel cell and a supply amount of fuel are controlled by the adjuster.

5. The fuel cell apparatus according to claim 4, wherein at least one of the fuel chamber, water storage chamber and the adjuster has the fuel detection device.

6. The fuel cell apparatus according to claim 3, which further comprises a fuel supply amount adjuster for adjusting a supply amount of fuel from the fuel chamber, a water supply amount adjuster for adjusting a supply amount of water from the water storage chamber, a mixing chamber for mixing fuel and water, and a control section for controlling supply amounts of fuel and water in response to the detection results of the fuel detection device and water detection device.

7. The fuel cell apparatus according to claim 1, wherein the fuel chamber, water storage chamber and the fuel cell are being capable of attached to and detachable detaching from the fuel cell apparatus.

8. The fuel cell apparatus according to claim 1, which further comprises an additional power source in addition to the fuel cell.

9. The fuel cell apparatus according to claim 9, wherein the additional power source is used as a driving device for the adjuster at the time of start of the fuel cell.

10. The fuel cell apparatus according to claim 1, which further comprises a load detection device for detecting load to be connected to the fuel cell apparatus, wherein the detection result by the load detection device is input in the control section of the adjuster, and wherein the concentration and the supply amount to the fuel cell supplied by the adjuster in response to the detection result by the load detection device are controlled.

11. The fuel cell apparatus according to claim 2, wherein the water recovery section uses a water protection-water permeable material, which is located between an air electrode and the water storage chamber, and is disposed in such a direction that water permeates from the air electrode to the water storage chamber.

12. The fuel cell apparatus according to claim 2, which further comprises a thermocouple, whose heating side is used to heat the fuel cell, and the cooling side of the thermocouple is used to recover water.

13. A method of controlling a fuel cell apparatus comprising a fuel cell for supplying electric power for driving a load, a fuel storage chamber for storing fuel, a water storage chamber for storing water, an adjuster, connected to the fuel chamber, water storage chamber and fuel cell, for controlling a fuel supply amount supplied from the fuel chamber and a water supply amount supplied from the water storage chamber, thereby to supply the fuel mixed with water to the fuel cell, and a temperature detection device for detecting temperature of the fuel cell, characterized in that the adjuster controls, in response to the detection result of the temperature detection device, the adjuster in such a manner that when the detection result is lower than a predetermined temperature, a concentration of fuel to be supplied to the fuel cell is set to be a higher level, and when the detection result is higher than the predetermined temperature, the fuel concentration is set to be a lower level.

14. A method of controlling a fuel cell apparatus comprising a fuel cell for supplying electric power for driving a load, a fuel storage chamber for storing fuel, a water storage chamber for storing water, an adjuster, connected to the fuel chamber, water storage chamber and fuel cell, for controlling a fuel supply amount supplied from the fuel chamber and a water supply amount supplied from the water storage chamber, thereby to supply the fuel mixed with water to the fuel cell, an additional power source other than the fuel cell, a charge-discharge control circuit for controlling the additional power source, and a load detection device for detecting information of the load, characterized in that the additional power source, which is connected to the fuel cell by means of the charge-discharge control circuit in parallel with each other, is capable of being charged and of detecting the charge amount, and in that the charge-discharge control circuit receives the detection result from the load detection device, and controls in such a manner that when the current of the load is higher than a predetermined value, current is discharged to a load in parallel with the fuel cell, and when the current of the load is smaller than the predetermined value, the additional power source is charged by the fuel cell.

15. The method of controlling fuel cell apparatus according to claim 14, which further comprises an input device for inputting stop signals for the apparatus and the load, wherein when the additional power source is not fully charged, the adjuster is not stopped, even when the supply of power from the fuel cell to the load is stopped by inputting the stop signals, but the adjuster is stopped in response to the detection result of the full charge of the additional power source.
